(19) United States
(12) Patent Application Publication
(10) Pub. No.: US 2014/0110357 A1
(43) Pub. Date: Apr. 24, 2014

(54) SHAKER TABLE WITH INERTIAL GAS/FLUID SEPARATION MEANS

(71) Applicant: ACCEDE ENERGY SERVICES LTD., Red Deer Country (CA)

(72) Inventors: ALVIN CUNNINGHAM, Leduc (CA); CRAIG HAMMOND, Leduc (CA)

(73) Assignee: ACCEDE ENERGY SERVICES LTD., Red Deer Country (CA)

(21) Appl. No.: 13/658,035

(22) Filed: Oct. 23, 2012

(51) Int. Cl. B01D 33/00

(52) U.S. Cl. 210/780; 210/188; 210/85

(57) ABSTRACT

An apparatus and method for use in a solids control system to separate drilling fluid from drill cuttings. The apparatus comprises at least one shaker screen for supporting drilling fluid contaminated drill cuttings within a shaker; a vacuum system operatively connected to at least a portion of the at least one shaker screen, effective to draw air and/or drilling fluid through the at least one shaker screen; and at least one inertial gas-liquid separation device operatively connected to the vacuum system, effective to remove liquid particles from a gas-liquid stream within the vacuum system. A method for operating the apparatus within a shaker system is also described.

### FIELD OF INVENTION

The present invention relates to solids control generally, and more specifically, to shakers used to separate drilling fluid from drill cuttings. In particular, the present invention relates to a shaker apparatus comprising at least one inertial gas-liquid separation device.

### BACKGROUND OF THE INVENTION

Solids control is used in oil and gas drilling operations, as well as in mining and other industries, to separate solids from the drilling fluids, or ‘mud’ used in the drilling process. These drilling fluids can have several functions, including lubrication and cooling of the drill bit, as well as to convey drilled cuttings away from a bore hole. The fluids are typically a mixture of various chemicals in a water or oil based solution, and can be very costly. To reduce these costs, and lessen the impact of these potentially toxic chemicals on the environment, it is desirable to recover drilling fluids from the drilled cuttings before they are disposed of.

Shale shakers have been used for decades in solids control processes to recover drilling fluid. They typically comprise a number of rectangular screens arranged in a basket, or ‘bed’, having one open discharge end and a solid walled feed end. The basket is arranged to receive recovered drilling mud at the feed end, and a skip or ditch is provided beneath the open discharge end of the basket to receive solids in which fluid has been mostly removed from the drill cuttings. A specialized motor, or vibrator, applies a vibratory force to the shaker bed and causes the basket and screens fixed thereto to shake. Solids laden mud is introduced at the feed end of the basket on to the screens. The shaking motion imparted by the motor to the basket induces the solids to move along the screens towards the open discharge end, while drilling fluid passes through the screens and is received into a receptor for further processing.

The present invention is directed to improvements in shale shaker technology which improves the separation process through the provision of an inertial gas/liquid separator, which functions to remove or reduce the content of certain gases that may be present in the drilling fluid.

### SUMMARY OF THE INVENTION

It has been found that prior art shaker tables which employ a vacuum pump to assist in separating drilling fluid from drill tailings which are being passed along such shaker table are very difficult to operate effectively for consistent performance. Problematically, at times the vacuum pump draws air through the tailings with execessive force such that tailings, even though not able to be drawn through the screen, become entrained in the screen, and clog further operation. Alternatively, at the same speed of the vacuum pump, at other times the vacuum pressure has been found to be insufficient to sufficiently separate liquid entrained in the tailings from such drill tailings.

It has been postulated, without being held to such theory, that undesirable “slugs” of fluid pass from time to time to the vacuum pump, undesirably causing pressure fluctuations in the vacuum pressure supplied to the screens, causing a “swing” in vacuum pressure from too much vacuum being supplied, to too little vacuum pressure being supplied when a “slug” of liquid enters the pump and momentarily causes a drop in vacuum pressure being exerted by the pump.

Accordingly, it is an object of the invention to provide an improved shaker table comprising an inertial gas/fluid separation means.

Alternatively, or in addition, it is a further object of the invention to make a more uniform application of vacuum pressure being supplied to a shaker table, to avoid undesirable pressure swings and thus non-consistent application of vacuum pressure to vacuum screens.

Accordingly, in a first broad aspect of the present invention there is herein provided an apparatus for separating drilling fluid from drill cuttings on a shaker, the apparatus comprising:
at least one shaker screen for supporting drilling fluid contaminated drill cuttings within the shaker;
a vacuum system operatively connected to at least a portion of the at least one shaker screen, effective to draw air and/or drilling fluid through the at least one shaker screen; and
at least one inertial gas-liquid separation device operatively connected to the vacuum system, effective to remove liquid particles from a gas-liquid stream within said vacuum system.

In a further alternative broad aspect of the present invention, such invention comprises a shaker table apparatus for separating drilling fluid from drill cuttings, the apparatus comprising:
at least one shaker screen for supporting drilling fluid contaminated drill cuttings;
vibratory means for vibrating said drill cuttings on said at least one shaker screen;
a vacuum system comprising a vacuum pump, operatively connected to at least a portion of the at least one shaker screen, effective to draw air and drilling fluid through the at least one shaker screen; and
at least one inertial gas-liquid separation device, interposed between said shaker screen and said vacuum pump, effective to remove or partially remove liquid particles from a gas-liquid stream prior to said liquid particles entering said vacuum pump.

In certain embodiments, the apparatus may also comprise a drilling fluid collection system for collecting separated drilling fluid from the inertial gas-liquid separation device, the vacuum system and/or from the underside of the at least one screen. The apparatus may additionally comprise a gas collection system for collecting and transporting gas(es) from the gas-liquid stream to a gas containment system.

In further embodiments, the inertial gas-liquid separation device may comprise an impactor against which said gas-liquid stream is passed. The impactor may also be adapted to cause directional change in a path followed by the gas-liquid stream within the vacuum system, thereby effecting liquid separation. In yet further embodiments, the inertial gas-liquid separation device may comprise a network of fibers and/or impingement barriers which define at least one tortuous path to be followed by gas molecules within the gas-liquid stream.

Without wishing to be limiting, the vacuum system described above may comprise:
a manifold for operative connection to at least a portion of the at least one shaker screen;
a vacuum hose operatively connected to the manifold; and
a vacuum pump operatively connected to the vacuum hose.

In the above embodiment, the inertial gas-liquid separation device may be connected to the vacuum pump via the manifold.

The apparatus may also comprise at least one tray positioned below the shaker screen(s), adapted to support the shaker screen(s) within the apparatus and to receive fluid which passes through the screen(s). In addition, in further non-limiting embodiments, the tray(s) may be structured so as to define a plenum area below the shaker screen(s), sloping towards a drain which connects to at least one inertial gas-liquid separation device. In such embodiments, the inertial gas-liquid separation device(s) may comprise an inertial gas-liquid separator valve, positioned below the drain(s), and have at least one outlet for removal of fluid droplets from the gas-liquid stream.

In one preferred embodiment of the gas-liquid inertial separation device of the present invention, such comprises a horizontal ‘t’ shaped junction, with an upper aperture in communication with a tray member and disposed below said at least one shaker screen for drawing a gas-liquid stream in a downward direction from said shaker screen, and having an intermediate aperture disposed at right angles to said downward direction for withdrawing gas horizontally outwardly from said gas-liquid mixture stream flowing downwardly, and further having a lower aperture through which a substantially liquid stream passes having gas withdrawn therefrom.

Referring to the vacuum system described above, the manifold may in particular embodiments include a plurality of valves for operative connection to the vacuum pump and the shaker screen(s). In addition, yet without wishing to be limiting, the vacuum pump may in certain embodiments be adjustable to control the vacuum pressure.

In the described apparatus, the shaker may include a frame which holds the at least one shaker screen in position, and at least one vibrator motor operatively connected to the frame to vibrate the at least one shaker screen during operation.

In further embodiments, which are non-limiting, the apparatus may be configured with one or more gas sensors (e.g. within the vacuum system) for measuring the quantity and/or composition of gas released from the drilling fluid. In addition, the shaker may be configured with a mass measurement system, such as a sensor (or sensors) connected to the shaker for measuring the relative mass of drill cuttings and fluid on the shaker.

There is also herein provided herein a method of separating drilling fluid from drill cuttings on a shaker. The method comprises:
introducing drill cuttings contaminated with drilling fluid to an upstream end of a shaker bed having at least one shaker screen;
applying a vacuum force to the at least one shaker screen while operating the shaker bed, the vacuum force being effective to draw gas and/or drilling fluid through the at least one shaker screen; and
passing at least a portion of the gas and/or drilling fluid through an inertial gas-liquid separation device to remove liquid particles from a gas-liquid stream.

The above method may, in certain embodiments, further comprise a step of collecting drilling fluid separated from the drill cuttings by the inertial gas-liquid separation device and/or from the underside of the at least one screen.

In yet further embodiments, the method may also comprise a step of collecting gas from the gas-liquid stream to a gas containment system.

Further embodiments of the described apparatus and method will be apparent from the detailed description that follows, together with the appended drawings.

### BRIEF DESCRIPTION OF THE DRAWINGS

These and other features of the invention will become more apparent from the following description in which reference is made to the appended drawings, wherein:

FIG. 1 shows an example of a shaker table comprising a plurality of tiered shaker screens, in accordance with an embodiment of the invention described herein;

FIG. 2 shows an example of a shaker screen that may be used with the shaker table shown in FIG. 1;

FIG. 3 shows a portion of the underside of the shaker table shown in FIG. 1, illustrating two inertial gas-liquid separator valves, in accordance with an embodiment of the invention described herein;

FIG. 4 shows an example of a vacuum manifold for use with the apparatus in accordance with an embodiment of the invention described herein;

FIG. 5 shows an example of a vacuum system for use with the apparatus in accordance with an embodiment of the invention described herein;

FIG. 6 shows a portion of an example of a shaker and associated vibrator motor, in accordance with an embodiment of the invention described herein;

FIG. 7 shows an example of a hopper, or base, for use with an apparatus as described herein;

FIG. 8 shows a portion of an example of a shaker and associated vibrator motor, and illustrates an inertial gas-liquid separator valve, in accordance with an embodiment of the invention described herein; and

FIG. 9 shows an example of a container unit for housing the apparatus of the present invention.

### DETAILED DESCRIPTION

Described herein with reference to the drawings is an improved shaker table for a shale shaker system used in drilling fluid recovery. The shaker table is equipped with an inertial gas-liquid separation device, which is employed to at least partially remove gas(es) from the drilling fluid, or drilling mud, during the recovery process.

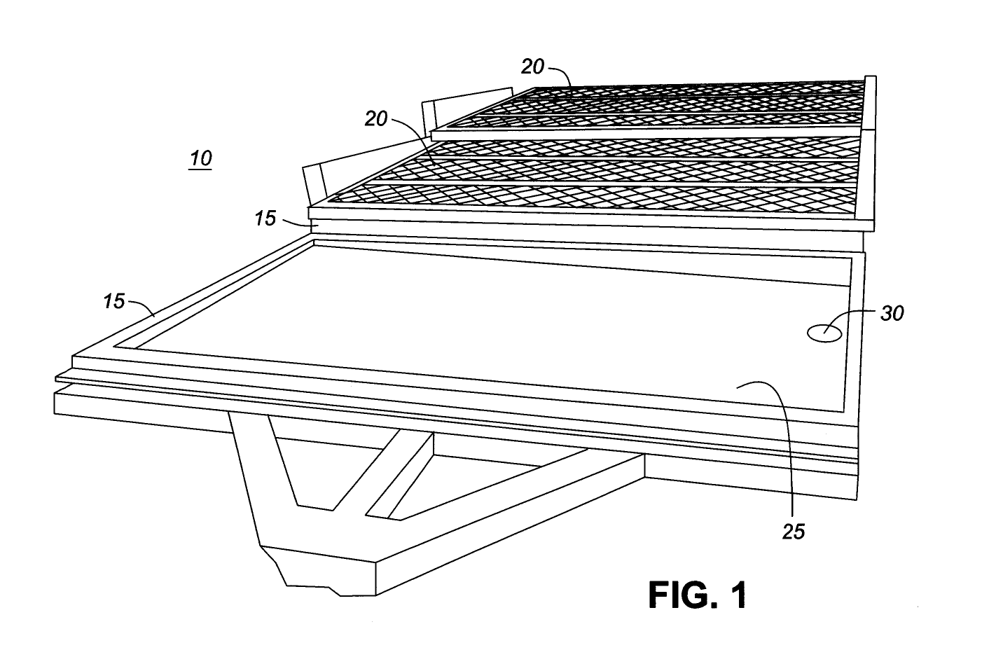

An embodiment of the shaker table is shown in FIG. 1, which illustrates a shaker table 10 including three tiered trays 15. The trays 15 are designed to support a series of screens 20, and have a sloped base portion 25 to facilitate draining of drilling fluid recovered in the process towards the drain valve aperture 30. Table designs with more or less than three shaker screens 20 are also envisioned, and are encompassed within the scope of the invention as described herein.

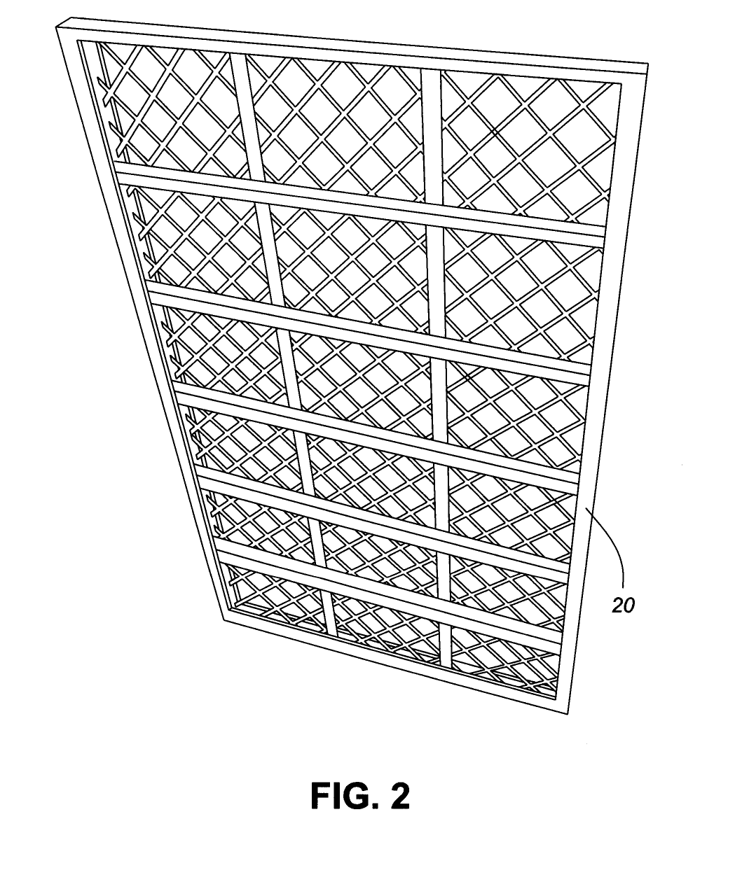

The screens used in the shaker table illustrated in FIG. 1 are generally known in the art, and have been described in detail previously (e.g. in U.S. Pat. No. 7,581,647 and WO 2011/113132, both of which are incorporated herein by reference). A generalized illustration of an embodiment of the shaker screen 20 is shown in FIG. 2. Without wishing to be limiting in any way, the shaker screen 20 will generally have a defined particle size limit. In certain embodiments it may be desirable for the screens to be anywhere from about 50 to about 325 mesh.

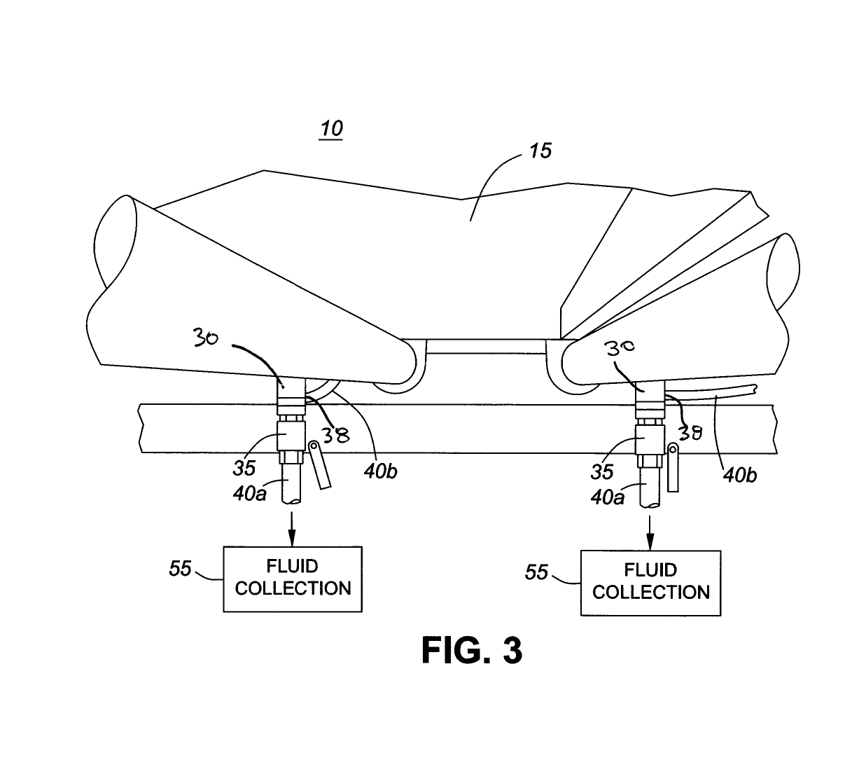

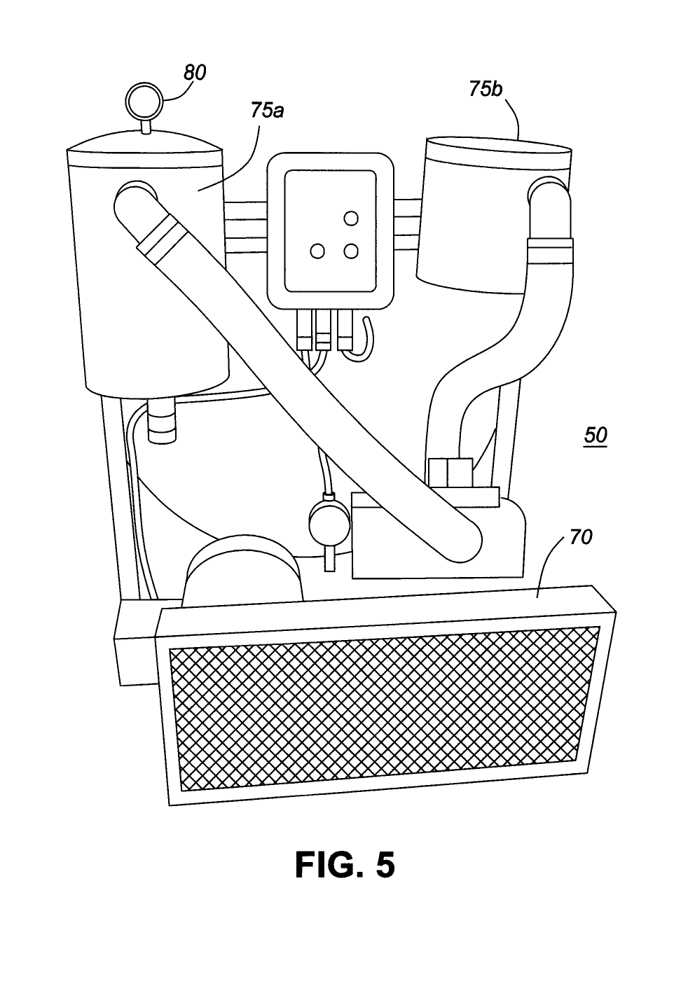

FIG. 3 illustrates a portion of the underside of the shaker table 10 showing a portion of the supporting structure of the trays 15 and two inertial gas-liquid separation valves 35, each connected to the respective drain valve apertures 30 of two of the trays. Tubing 40(a,b) connects the inertial gas-liquid separation valves to a vacuum system 50 (see FIG. 5) which may, in certain non-limiting embodiments comprise a gas collection system, and a fluid collection system 55.

The inertial gas-liquid separation valves 35 are one example of the inertial gas-liquid separator envisioned by the present invention. In general, an inertial gas-liquid separator may remove liquid particles from a gas-liquid stream by accelerating a stream or aerosol to high velocities through nozzles or orifices, and directing same against an impactor, typically causing a sharp directional change, effecting liquid separation. The inertial gas-liquid separator may also pass a gas through a network, such as fibers and impingement barriers, such that the gas stream follows a tortuous path around these obstacles while liquid droplets go in straighter paths, impacting these obstacles. Once this occurs, the droplet or particle loses velocity and/or coalesces, and eventually falls downwards towards the fluid collection system 55.

In the embodiment of the gas-liquid inertial separation device (valve) 35 shown in FIG. 3, such comprises a horizontal ‘t’ shaped junction, with an upper aperture in communication with a drain valve aperture 30 disposed below said at least one shaker screen 15 for drawing a gas-liquid stream in a downward direction from said shaker screen 15, and having an intermediate aperture 38 disposed at right angles to said downward direction for withdrawing gas horizontally outwardly from said gas-liquid mixture stream flowing downwardly, and further having a lower aperture through 35 which a substantially liquid stream passes having gas withdrawn therefrom.

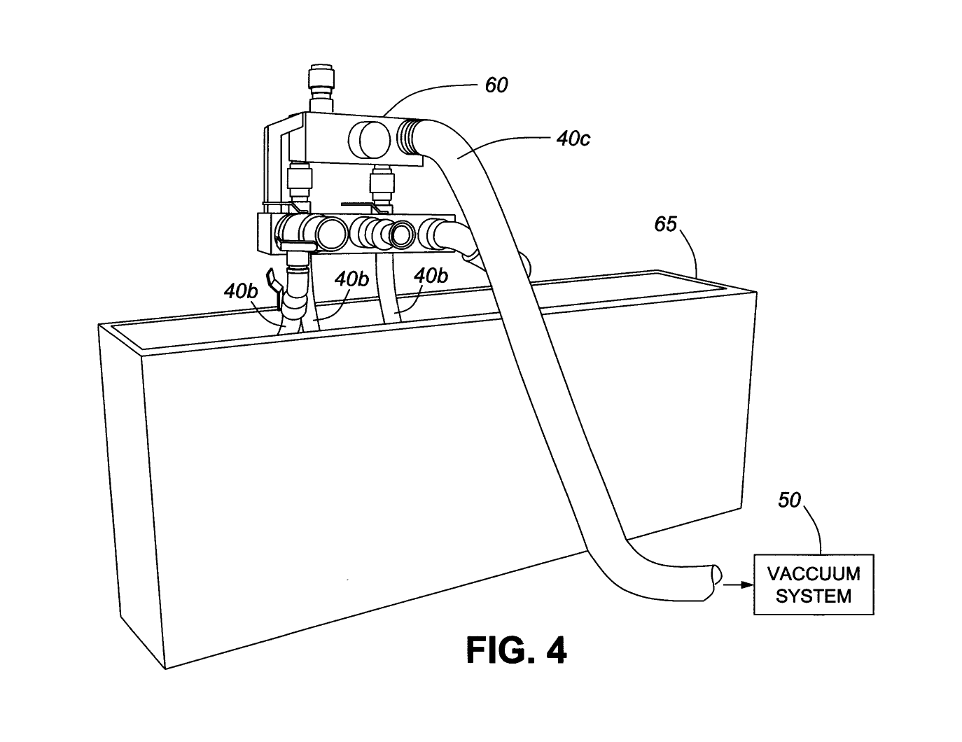

FIG. 4 shows an example of a distribution manifold 60 comprising a plurality of ports for connecting to vacuum hoses 40 (a,b,c) and valves which connect the manifold 60 to the vacuum system 50 and to the valves 35 of the shaker table. The distribution manifold 60 can be designed in various embodiments to suit the particular design and configuration of the shaker and vacuum systems employed. In this particular embodiment the distribution manifold 60 is placed within a shale bin 65, and can be configured to operate with one or more shaker tables with a varying number of shaker screens 20 and trays 15.

The distribution manifold 60 can be connected, via vacuum tubing 40c, to the vacuum system 50. The vacuum system 50 facilitates the recovery of drilling fluid by drawing air, drilling fluid and any residual gases present in the drilling mud through the screens 20 of the shaker table 10. One example of the vacuum system 50 is shown in FIG. 5. The vacuum system may comprises a vacuum pump 70 operably configured within the system, one or more storage vessels or accumulators 75 (a,b), gauge(s) 80 and sensors (not shown), as well as an appropriate power source. The vacuum system 50 may also comprise, if desired, a gas collection system and/or secondary fluid/gas separation means. Vacuum systems as described previously, for example in WO 2011/113132 (incorporated herein by reference) may also be employed in accordance with the improved shaker table described herein.

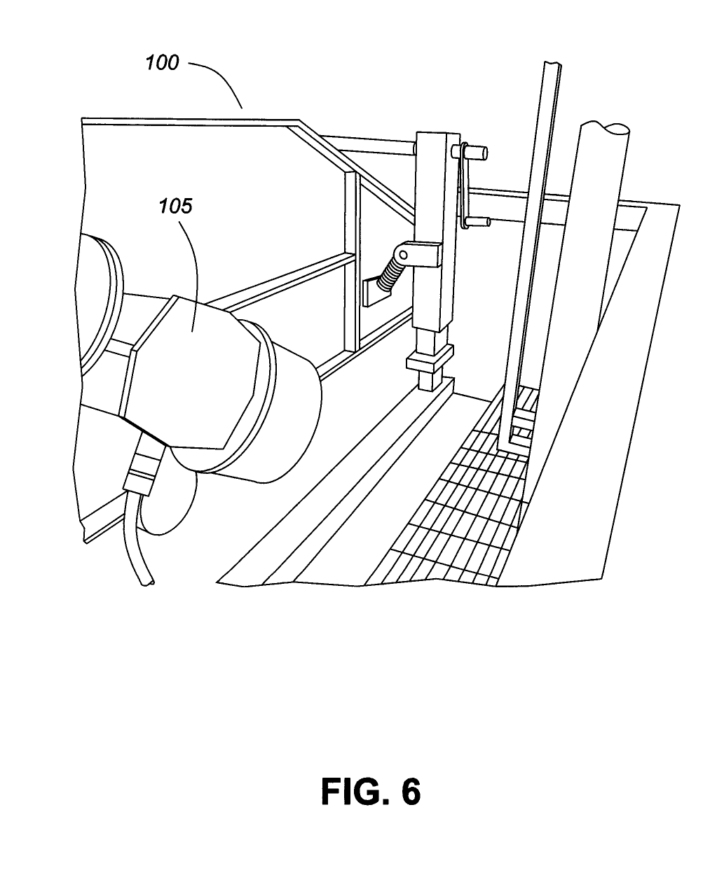

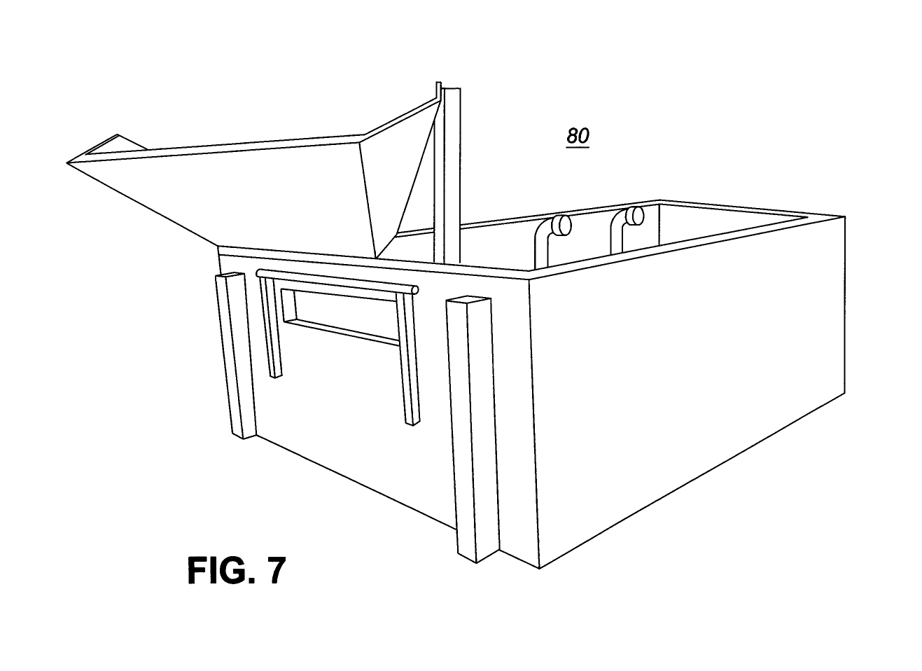

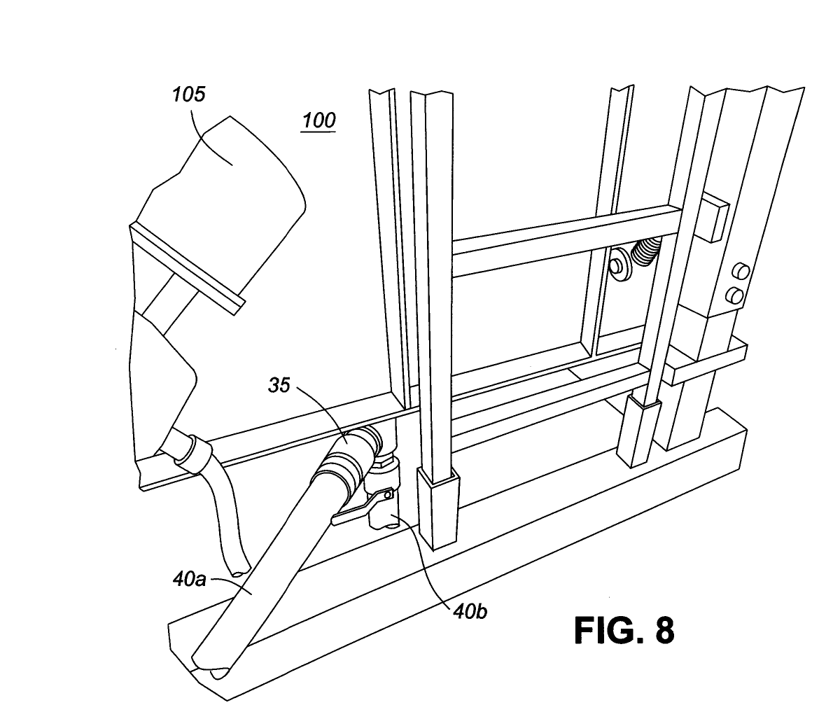

The shaker table 10 described herein will be adapted for use within a shaker apparatus, or bed 100, such as that illustrated in part in FIG. 6. The shaker 100 typically includes one or more motors 105 and a resilient structure adapted to impart mechanical shaking energy to the screens of the shaker table 10. A hopper, or ‘base’ 80 as shown in FIG. 7 may also be included within the system, in certain embodiments, and can function both as a platform for the shaker 100 and optionally as a collection pan for the fluid processed by the shaker table 10. The base 80 can be structured according to the needs of the drilling fluid recovery system. For instance, it can come in different depths to accommodate larger quantities of drilling fluid as well as have ports for returning the recovered drilling fluid to the mud system. It is also expected that the base will have appropriate allowances for the vacuum hoses and fluid recovery conduits of the system described herein, as illustrated for example in FIG. 8.

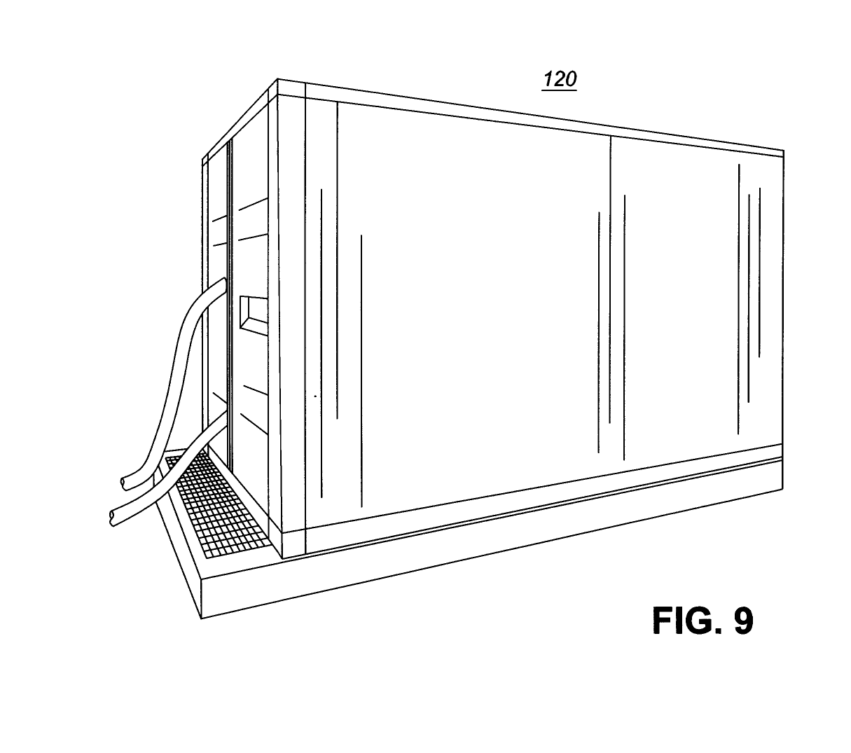

In addition, the vacuum system 50 and shaker table 10 may, in certain optional embodiments, be housed within a container 120 as illustrated in FIG. 9. Housing these and other components of the shaker system in a contain this way is particularly useful if transportation from site-to-site is envisioned.

One or more currently preferred embodiments have been described by way of example. It will be apparent to persons skilled in the art that a number of variations and modifications can be made without departing from the scope of the invention as defined in the claims.

What is claimed is:

1. An apparatus for separating drilling fluid from drill cuttings on a shaker, the apparatus comprising:
at least one shaker screen for supporting drilling fluid contaminated drill cuttings within a shaker;
a vacuum system operatively connected to at least a portion of the at least one shaker screen, effective to draw air and/or drilling fluid through the at least one shaker screen; and
at least one inertial gas-liquid separation device operatively connected to the vacuum system, effective to remove liquid particles from a gas-liquid stream within said vacuum system.

2. The apparatus according to claim 1, further comprising:
a drilling fluid collection system for collecting separated drilling fluid from the inertial gas-liquid separation device, the vacuum system and/or from the underside of the at least one screen.

3. The apparatus according to claim 1, further comprising:
a gas collection system for collecting and transporting contaminating gases from the gas-liquid stream to a gas containment system.

4. The apparatus according to claim 1, wherein the inertial gas-liquid separation device comprises an impactor against which said gas-liquid stream is passed.

5. The apparatus according to claim 4, wherein the impactor causes directional change in a path followed by said gas-liquid stream within said vacuum system and effects liquid separation.

6. The apparatus according to claim 1, wherein the inertial gas-liquid separation device comprises a network of fibers and/or impingement barriers which define at least one tortuous path to be followed by gas molecules within said gas-liquid stream.

7. The apparatus according to claim 1, wherein the vacuum system comprises:
a manifold for operative connection to at least a portion of the at least one shaker screen;
a vacuum hose operatively connected to the manifold; and
a vacuum pump operatively connected to the vacuum hose.

8. The apparatus according to claim 7, wherein the inertial gas-liquid separation device is operatively connected to the vacuum pump via said manifold.

9. The apparatus according to claim 1, wherein the apparatus comprises at least one tray below each of said at least one shaker screen and adapted to support the at least one shaker screen in the apparatus, and to receive fluid which passes therethrough.

10. The apparatus according to claim 1, wherein each of said trays defines a plenum area below said at least one shaker screen which is sloped towards a drain, said drain connects to said at least one inertial gas-liquid separation device.

11. The apparatus according to claim 10, wherein the inertial gas-liquid separation device comprises at least one inertial gas-liquid separator valve positioned below said drain, and at least one outlet for removal of fluid droplets from the gas-liquid stream.

12. The apparatus according to claim 7, wherein the manifold has a plurality of valves for operative connection to the vacuum pump and the at least one shaker screen.

13. The apparatus according to claim 7, wherein the vacuum pump is adjustable to control the vacuum pressure.

14. The apparatus according to claim 1, wherein the shaker includes a frame which holds the at least one shaker screen in position, and at least one vibrator motor operatively connected to the frame to vibrate the at least one shaker screen during operation.

15. The apparatus according to claim 1, further comprising a gas sensor within the vacuum system for measuring the quantity and/or composition of gas released from the drilling fluid.

16. The apparatus according to claim 1, further comprising at least one mass measurement sensor connected to the shaker for measuring the relative mass of drill cuttings and fluid on the shaker.

17. A method of separating drilling fluid from drill cuttings on a shaker comprising:
introducing drill cuttings contaminated with drilling fluid to an upstream end of a shaker bed having at least one shaker screen;
applying a vacuum force to the at least one shaker screen while operating the shaker bed, the vacuum force being effective to draw gas and/or drilling fluid through the at least one shaker screen; and
passing at least a portion of the gas and/or drilling fluid through an inertial gas-liquid separation device to remove liquid particles from a gas-liquid stream.

18. The method according to claim 17, further comprising:
collecting drilling fluid separated from the drill cuttings by the inertial gas-liquid separation device and/or from the underside of the at least one screen.

19. The method according to claim 18, further comprising:
collecting gas from the gas-liquid stream to a gas containment system.

20. The method according to claim 17, wherein the inertial gas-liquid separation device comprises an impactor against which said gas-liquid stream is passed.

21. The method according to claim 20, wherein the impactor causes directional change in a path followed by said gas-liquid stream within said vacuum system and effects liquid separation.

22. The method according to claim 17, wherein the inertial gas-liquid separation device comprises a network of fibers and/or impingement barriers which define at least one tortuous path to be followed by gas molecules within said gas-liquid stream.

23. A shaker table apparatus for separating drilling fluid from drill cuttings, the apparatus comprising:
at least one shaker screen for supporting drilling fluid contaminated drill cuttings;
vibratory means for vibrating said drill cuttings on said at least one shaker screen;
a vacuum system comprising a vacuum pump, operatively connected to at least a portion of the at least one shaker screen, effective to draw air and drilling fluid through the at least one shaker screen; and
at least one inertial gas-liquid separation device, interposed between said shaker screen and said vacuum pump, effective to remove liquid particles from a gas-liquid stream prior to said liquid particles entering said vacuum pump.

24. The apparatus according to claim 23, wherein said at least one gas-liquid separation device comprises a horizontal ‘t’ shaped junction, with an upper aperture in communication with a tray member and disposed below said at least one shaker screen for drawing a gas-liquid stream in a downward direction from said shaker screen, and having an intermediate aperture disposed at right angles to said downward direction for withdrawing gas horizontally outwardly from said gas-liquid mixture stream flowing downwardly, and further having a lower aperture through which a substantially liquid stream passes having gas withdrawn therefrom.
